(19) United States
(12) Patent Application Publication
(10) Pub. No.: US 2012/0225591 A1
(43) Pub. Date: Sep. 6, 2012

(54) THIN PLUG CONNECTOR AND ASSEMBLING METHOD THEREOF

(75) Inventor: Pei-Chiao Hung, New Taipei City (TW)

(73) Assignee: ANT PRECISION INDUSTRY CO., LTD., Taipei City (TW)

(21) Appl. No.: 13/411,128

(22) Filed: Mar. 2, 2012

(30) Foreign Application Priority Data
Mar. 4, 2011 (TW) 100107379

(51) Int. Cl. H01R 13/04

(52) U.S. Cl. 439/692

(57) ABSTRACT

A thin plug connector includes an insulator body having a plate protruding therefrom, a mating slot formed around a periphery of the plate, a plurality of grooves, and at least one hole adjacent to the mating slot. A plurality of terminals are inserted into the grooves. Each terminal has a contact portion embedded at one side of the plate, and a soldering portion disposed at a bottom side of the insulator body. A casing has a base plate, a side plate bent from a longitudinal side edge of the base plate and attached to a longitudinal sidewall of the insulator body, and at least one resilient sheet extending through the hole and closer to the mating slot than the hole so that the base plate abuts against the bottom side.

### CROSS-REFERENCE TO RELATED APPLICATION

This application claims priority of Taiwanese Application No. 100107379, filed on Mar. 4, 2011.

### BACKGROUND OF THE INVENTION

1. Field of the Invention

This invention relates to a thin plug connector, and more particularly to a thin plug connector that is used in conjunction with a socket connector.

2. Description of the Related Art

Referring to FIG. 1, a thin plug connector 9, as disclosed in Taiwanese Patent No. M387390, is adapted to be inserted into a socket connector, and includes a metal casing 91, an insulator body 92, and a rectangular metal cover 93. The insulator body 92 has a mating slot 921, and a plurality of terminals 922 disposed on the insulator body 92 within the mating slot 921. The metal cover 93 has a periphery provided with a plurality of spaced-apart resilient sheets 931. When the cover 93 is connected to the insulator body 92, the resilient sheets 931 can engage a periphery of the mating slot 921 for abutment thereagainst of a socket connector that is inserted into the mating slot 921.

An assembling method of the thin plug connector 9 is performed by first moving the cover 93 in the direction of an arrow (A1) to engage with the insulator body 92, after which the casing 91 is moved in the direction of an arrow (A2) to engage with an assembly of the cover 93 and the insulator body 92. The cover 93 is pressed against the insulator body 92 through pressing plates 911 of a periphery of the casing 91.

### SUMMARY OF THE INVENTION

An object of the present invention is to provide a thin plug connector that can save assembling time and production costs thereof.

Another object of the present invention is to provide an assembling method of the aforesaid thin plug connector.

According to one aspect of the present invention, a thin plug connector comprises an insulator body, a plurality of terminals, and a casing. The insulator body has a plate, a mating slot, a plurality of grooves, and at least one hole. The plate protrudes from the insulator body. The mating slot is formed around a periphery of the plate. The hole is adjacent to the mating slot. The terminals are inserted into the grooves. Each of the terminals has a contact portion and a soldering portion. The contact portion is embedded at one side of the plate. The soldering portion is disposed at a bottom side of the insulator body. The casing has a base plate, a side plate, and at least one resilient sheet. The side plate is bent from a longitudinal side edge of the base plate and is attached to a longitudinal sidewall of the insulator body. The resilient sheet extends through the hole, and is closer to the mating slot than the hole, so that the base plate abuts against the bottom side.

According to another aspect of the present invention, an assembling method of the thin plug connector for use in conjunction with a plurality of cables is provided. The thin plug connector has an insulator body and a plurality of terminals, and each terminal has a contact portion and a soldering portion. The assembling method includes the following steps:

providing the insulator body that has the terminals such that the contact portions of the terminals are embedded at one side of the plate, and the soldering portions of the terminals are disposed at a bottom side of the insulator body, wherein the insulator body further has a mating slot and a hole, the mating slot is formed around a periphery of the plate, and the hole is adjacent to the mating slot; and

attaching a casing on the bottom side of the insulator body, wherein the casing includes a base plate, a sideplate, and a resilient sheet, besides, the sideplate is bent from a longitudinal side edge of the base plate, and the resilient sheet extends through the hole and is closer to the mating slot than the hole, so that the base plate abuts against the bottom side.

Through the aforesaid technical means, the advantage and efficiency of the thin plug connector of this invention reside in that it can save the assembling time and the production costs thereof.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of a thin plug connector disclosed in Taiwanese Patent No. M387390;

FIG. 2 is an exploded perspective view of a thin plug connector according to the first preferred embodiment of the present invention;

FIG. 3 is a schematic top view of an insulator body of the first preferred embodiment;

FIG. 4 is a bottom perspective view of the insulator body of the first preferred embodiment;

FIG. 5 is a perspective view of a terminal of the first preferred embodiment;

FIG. 6 is an exploded perspective view of a casing and the insulator body of the first preferred embodiment;

FIG. 7 is a perspective view of the casing and the insulator body of the first preferred embodiment in an assembled state;

FIG. 8 is a sectional view of the first preferred embodiment taken along line A-A of FIG. 7;

FIG. 9 is a sectional view of the first preferred embodiment taken along line B-B of FIG. 7;

FIG. 10 is a partially exploded perspective view of the first preferred embodiment;

FIG. 11 is an assembled perspective view of FIG. 10;

FIG. 12 is an exploded perspective view of a thin plug connector according to the second preferred embodiment of the present invention;

FIG. 13 is a perspective view of the second preferred embodiment in an assembled state;

FIG. 14 is a sectional view of the second preferred embodiment taken along line C-C of FIG. 13; and

FIG. 15 is a sectional view of the second preferred embodiment taken along line D-D of FIG. 13.

### DETAILED DESCRIPTION OF THE PREFERRED EMBODIMENTS

The above-mentioned and other technical contents, features, and effects of this invention will be clearly presented from the following detailed description of two preferred embodiments in coordination with the reference drawings.

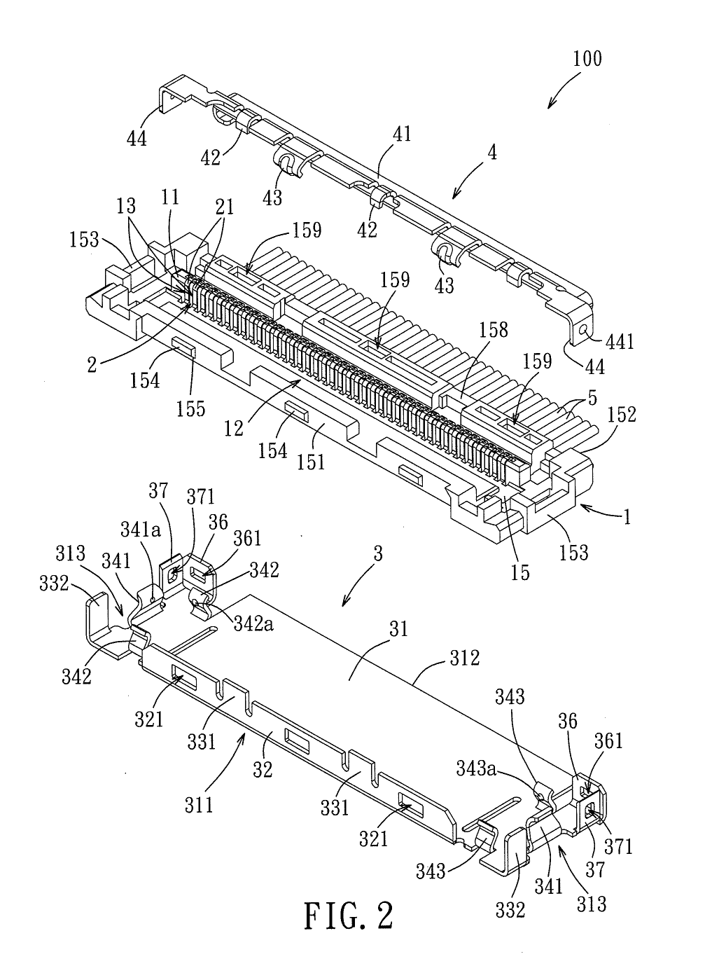

Referring to FIGS. 2 to 11, a thin plug connector 100 according to the first preferred embodiment of the present invention is configured as a cable connector, and comprises an insulator body 1, a plurality of terminals 2, and a metal casing 3.

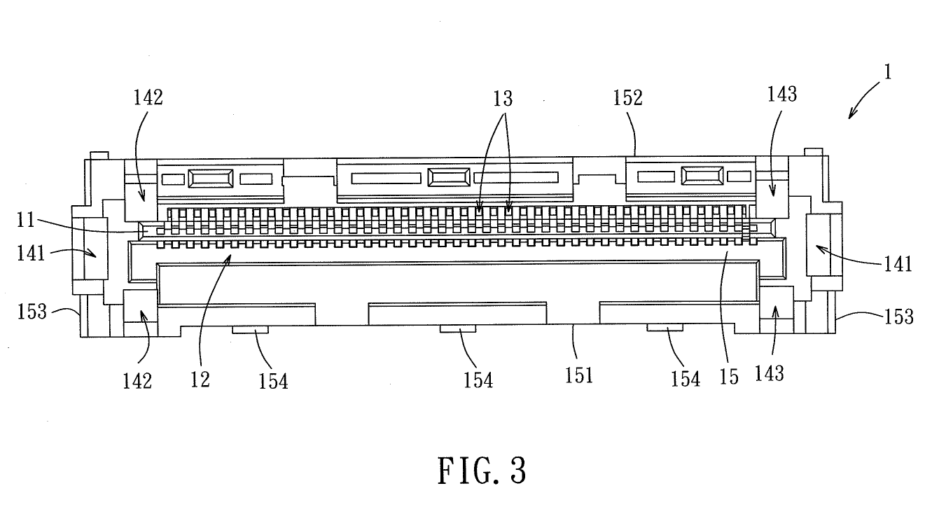

With reference to FIGS. 2 and 3, the insulator body 1 has a plate 11, a mating slot 12, a plurality of grooves 13, and a plurality of holes 141, 142, 143 (see FIG. 3). The plate 11 protrudes from the insulator body 1. Concretely speaking, the plate 11 is a thin plate that protrudes from a bottom wall 15 of the insulator body 1. The terminals 2 are disposed along the plate 11. The bottom wall 15 has a substantially rectangular contour shape. The insulator body 1 further has a first longitudinal sidewall 151, a second longitudinal sidewall 152 opposite to the first longitudinal sidewall 151, and two opposite short sidewalls 153. The first and second longitudinal sidewalls 151, 152 and the short sidewalls 153 surround the plate 11, and cooperate with the plate 11 to define the mating slot 12. The mating slot 12 is thus formed around a periphery of the plate 11. The grooves 13 are formed on the insulator body 1 and extend from the bottom wall 15 to the plate 11. The number of the grooves 13 is equal to the number of the terminals 2. Each groove 13 is adapted to be inserted by the corresponding terminal 2. The holes 141, 142, 143 penetrate the bottom wall 15, and are adjacent to the mating slot 12. Concretely speaking, the number of holes in this embodiment is six, two holes 141 are respectively formed in the left and right short sidewalls 153. Another two holes 142 are formed in the first longitudinal sidewall 151 adjacent to the respective holes 141. The remaining two holes 143 are formed in the second longitudinal sidewall 152 of the base plate 15 and are adjacent to the two holes 141. The holes 142 and the holes 143 are disposed on two opposite sides of the plate 11, respectively.

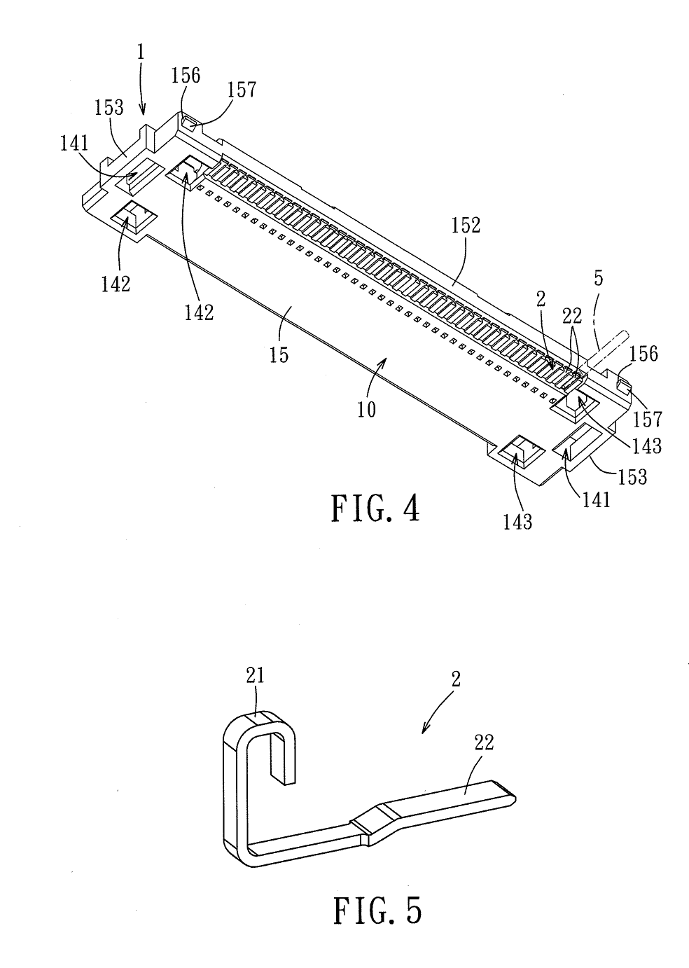

With reference to FIGS. 2 and 4, the first longitudinal sidewall 151 has a plurality of spaced-apart engaging projections 154. Each engaging projection 154 has a truncated pyramidal shape and a slanting peripheral face 155. The second longitudinal sidewall 152 also has a plurality of spaced-apart engaging projections 156. Each engaging projection 156 similarly has a truncated pyramidal shape and a slanting peripheral face 157. The engaging projections 156 are respectively proximate to the short sidewalls 153. The second longitudinal sidewall 152 further has a plurality of spaced-apart engaging grooves 159 formed in a top face 158 thereof. As shown in FIG. 2, the engaging grooves 159 are formed respectively in protruding portions of the top face 158. Alternatively, the top face 158 may have a uniform height.

With reference to FIGS. 2, 4 and 5, each terminal 2 is inserted into the corresponding groove 13 in the insulator body 1, and has a contact portion 21 and a soldering portion 22. The contact portion 21 is substantially U-shaped. The soldering portion 22 is substantially straight. When the terminal 2 is inserted into the corresponding groove 13, the contact portion 21 of the terminal 2 is embedded at one side of the plate 11, and the soldering portion 22 is, as shown in FIG. 4, exposed at a bottom side 10 (which is a bottom face of the bottom wall 15) of the insulator body 1.

The casing 3, as shown in FIG. 2, has a first base plate 31, a side plate 32, a plurality of pressing plates 331, 332, a plurality of first resilient sheets 341, 342, 343, a plurality of first buckling plates 36, and a plurality of second buckling plates 37. The first base plate 31 is substantially rectangular, and has a first longitudinal side edge 311, a second longitudinal side edge 312 opposite to the first longitudinal side edge 311, and two short side edges 313. The side plate 32 is bent from the first longitudinal side edge 311, and is provided with a plurality of spaced-apart engaging holes 321. The pressing plates 331 are connected to the side plate 32, and are arranged alternately with the engaging holes 321. The pressing plates 331 can be formed by stamping a portion of the side plate 32. The pressing plates 332 are respectively bent from the short side edges 313 of the first base plate 31, and are adjacent to the respective first longitudinal side edges 311.

Referring once again to FIGS. 2 and 4, the first resilient sheets 341, 342, 343 correspond in position to the holes 141, 142, 143 in the insulator body 1. Two first resilient sheets 341 are respectively bent from the short side edges 313 of the first base plate 31 opposite to each other. Another two first resilient sheets 342 are bent from the first longitudinal side edge 311 of the first base plate 31 and are respectively disposed at two opposite sides of the side plate 32. The remaining two first resilient sheets 343 are bent from the second longitudinal side edge 312 of the first base plate 31 and are respectively opposite to the first resilient sheets 342. Each of the first resilient sheets 341, 342, 343 has an S-shaped cross section, and has a projection (341a, 342a, 343a) (see FIG. 9) protruding toward the mating slot 12 or the plate 12. The first resilient sheets 341, 342, 343 respectively pass through the holes 141, 142, 143, and are closer to the mating slot 12 than the respective holes 141, 142, 143. This refers to the portions of the first resilient sheets 341, 342, 343 that are to be in contact with a mating connector. As such, when the mating connector (not shown) is inserted into the mating slot 12, the mating connector can contact the first resilient sheets 341, 342, 343.

With reference to FIG. 2, two first buckling plates 36 are bent from the second longitudinal side edge 312 in proximity to the respective short side edges 313, and are opposite to the side plate 32. Each first buckling plate 36 is provided with an engaging hole 361. The first resilient sheets 343 are disposed between the first buckling plates 36. Two second buckling plates 37 are respectively bent from the short side edges 313 of the first base plate 31 in proximity to the second longitudinal side edge 312. Each second buckling plate 37 has a limiting hole 371. Each first resilient sheet 341 is disposed between one of the second buckling plates 37 and a respective pressing plate 332.

In this embodiment, the thin plug connector 100 further includes a side cover 4. The side cover 4 covers the second longitudinal sidewall 152 of the insulator body 1 and cooperates with the casing 3 to form an effect of preventing electromagnetic interference (EMI). The side cover 4 includes a second base plate 41, a plurality of engaging hooks 42, a plurality of second resilient sheets 43, and two third buckling plates 44. The second base plate 41 is generally an elongated strip. The third buckling plates 44 are respectively bent from two opposite ends of the second base plate 41. Each third buckling plate 44 has a substantially semi-circular limiting projection 441 formed on an outer face thereof. The engaging hooks 42 and the second resilient sheets 43 are bent from one side of the second base plate 41 that is parallel to the second longitudinal sidewall 152. The engaging hooks 42 are respectively lodged in the engaging grooves 159 of the insulator body 1.

With reference to FIGS. 2 and 4, to assemble the thin plug connector 100, the terminals 2 are connected to the insulator body 1 by using either an insert molding or a conventional mechanical assembling method. In the insert molding method, the terminals 2 are first placed in a mold, and are then embedded in the insulator body 1 during the molding of the insulator body 1. In the conventional mechanical assembling method, the insulator body 1 is formed firstly, after which the terminals 2 are inserted into the grooves 13 of the insulator body 1. After the terminals 2 are connected to the insulator body 1, the contact portion 21 of each terminal 2 is embedded at one side of the plate 11, and the soldering portion 22 of each terminal 2 is disposed at and is exposed from the bottom side 10 (that is, the outer face of the bottom wall 15) of the insulator body 1, as best shown in FIG. 4.

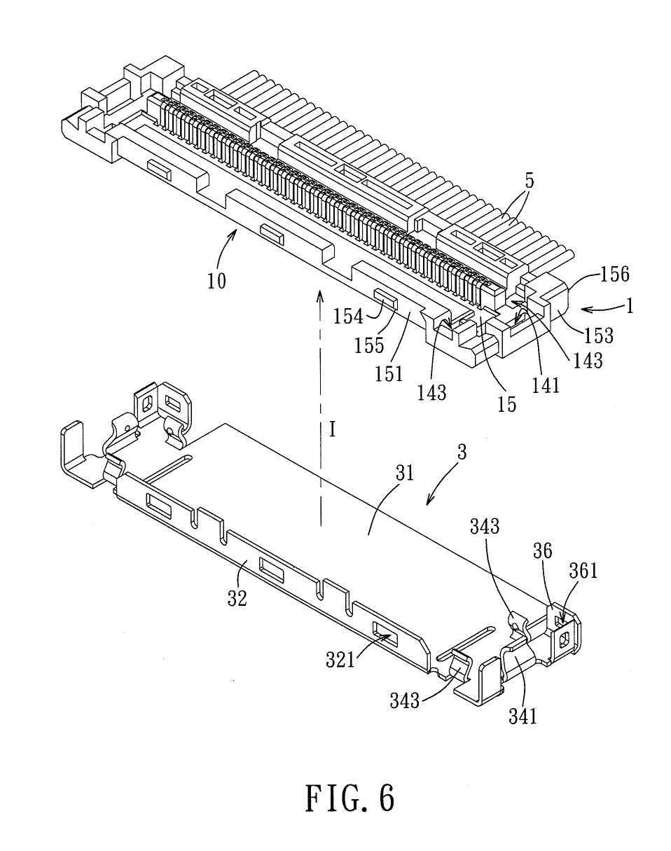

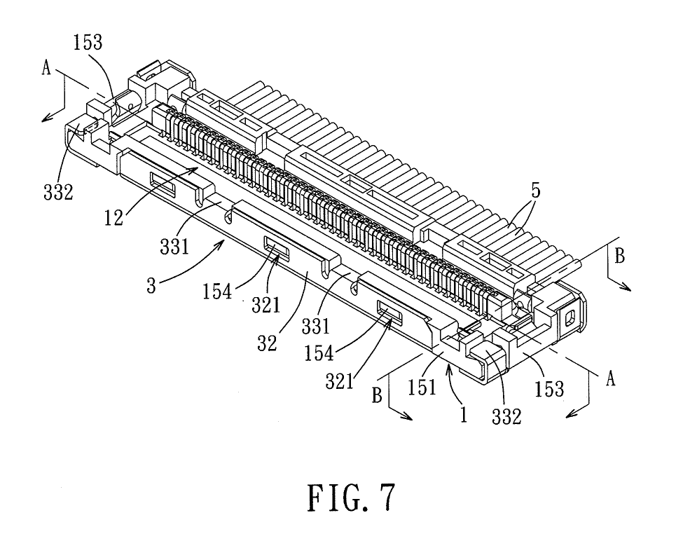

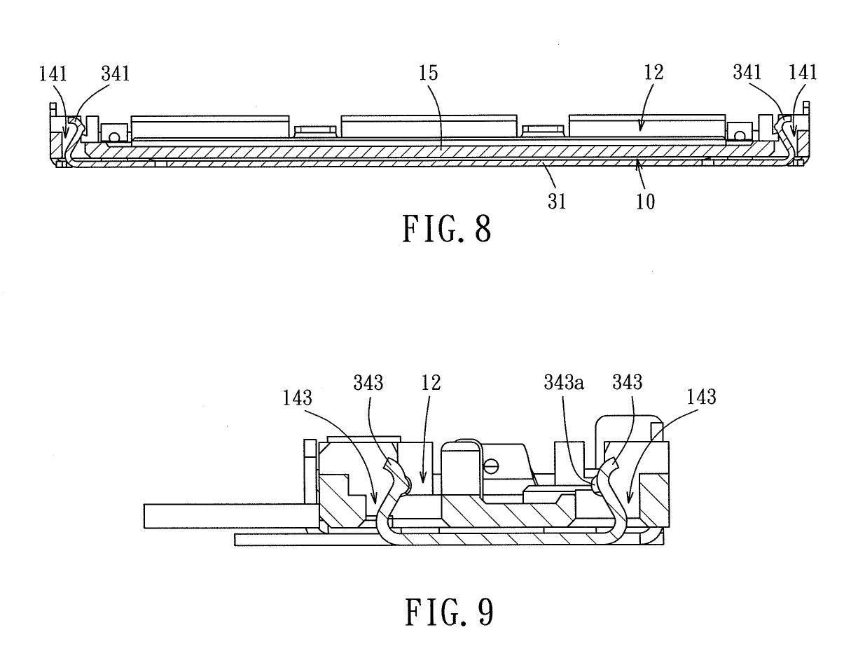

With reference to FIGS. 6 and 7, subsequently, the casing 3 is attached to the bottom side 10 of the insulator body 1. During assembly, the first base plate 31 faces the bottom side 10 of the first base plate 31, and is then moved in a direction (I) which is perpendicular to the first base plate 31 to the bottom side 10 of the insulator body 1, so that the engaging holes 321 in the side plate 32 can engage with the respective engaging projections 154 of the first longitudinal sidewall 151, and the engaging holes 361 in the first buckling plates 36 can engage with the respective engaging projections 156 (see FIG. 4) of the second longitudinal sidewall 152. The slanting peripheral face 155 of each engaging projection 154 serves to guide the engaging projection 154 into the respective engaging hole 321, and the slanting peripheral face 157 (see FIG. 4) of each engaging projection 156 also serves to guide the engaging projection 156 into the respective engaging hole 361. The first resilient sheets 341, 342, 343, as shown in FIGS. 8 and 9, extend through the respective holes 141, 142, 143, and are closer to the mating slot 12 than the holes 141, 142, 143, so that the first base plate 31 abuts against the bottom side 10 of the insulator body 1. Afterwards, as shown in FIG. 7, the pressing plates 331, 332 are bent to press against the first longitudinal sidewall 151 and the short sidewalls 153 of the insulator body 1.

Prior to attachment of the casing 3 to the insulator body 1, as shown in FIG. 4, preferably, a plurality of cables 5 (only one is shown in FIG. 4) are soldered or connected electrically and respectively to the soldering portions 22 of the terminals 2, after which the casing 3 is attached to the insulator body 1 so that the cables 5 are covered within the casing 3.

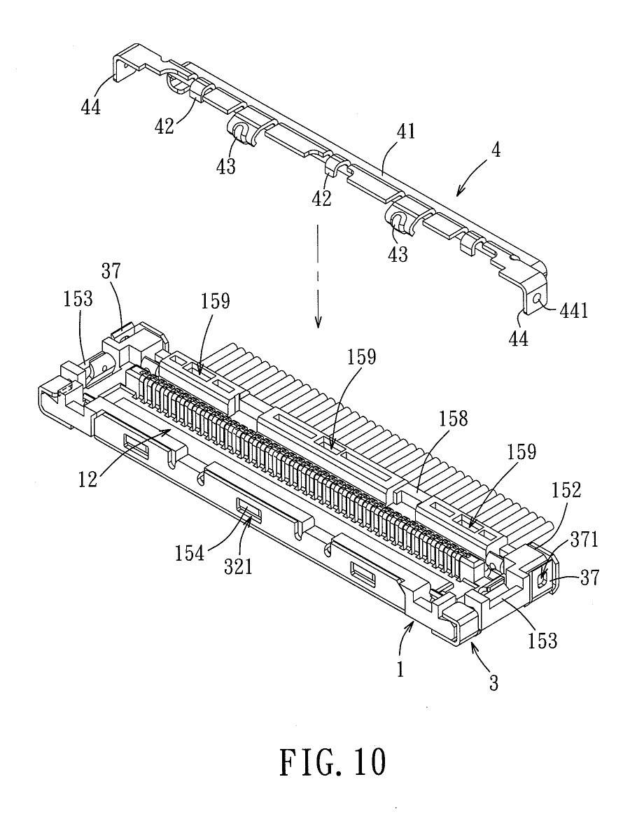

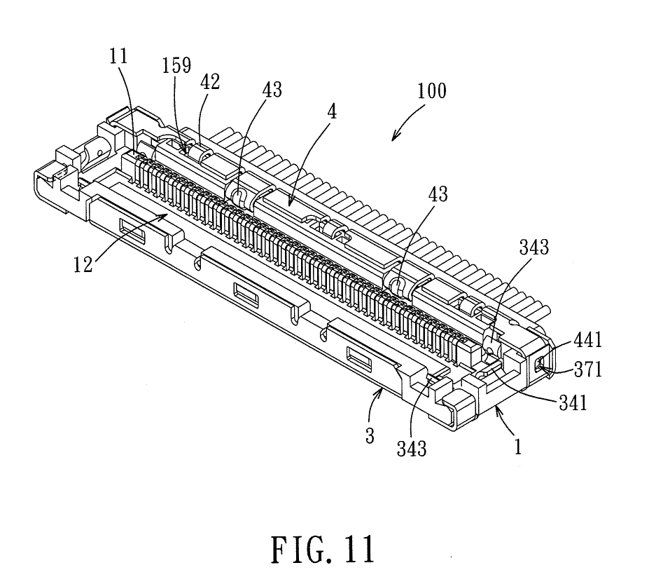

With reference to FIGS. 10 and 11, after the casing 3 is attached to the insulator body 1, the side cover 4 is then attached to the second longitudinal sidewall 152 of the insulator body 1 such that the side cover 4 and the casing 3 are interengaged. The side cover 4 is attached to the insulator body 1 by lodging the engaging hooks 42 in the corresponding engaging grooves 159 of the second longitudinal sidewall 152. The second resilient sheets 43 extend into the mating slot 12. Each third buckling plate 44 extends forward between one of the short sidewalls 153 and the corresponding second buckling plate 37, and the limiting projection 441 of each third buckling plate 44 is lodged in the limiting hole 371 of the corresponding second buckling plate 37, thereby engaging the side cover 4 to the casing 3. In this embodiment, the side cover 4 is configured as an elongated strip, and is connected only to the second longitudinal sidewall 152 of the insulator body 1.

When the casing 3 and the side cover 4 are connected to the insulator body 1, the first resilient sheets 341, 342, 343 and the second resilient sheets 43 extend into the mating slot 12 and surround the plate 11. Through this configuration, when the thin plug connector 100 is inserted into a socket connector (not shown), the projections (341a, 342a, 343a) of the first and second resilient sheets 341, 342, 343, 43 can abut against a periphery of the socket connector.

The assembling sequence of the casing 3 and the side cover 4 is not limited to the aforesaid disclosure. When assembling, the side cover 4 may first be attached to the insulator body 1, after which the casing 3 is attached to the insulator body 1.

The thin plug connector 100 may further include a pull strap (not shown) attached to the first base plate 31 of the casing 3 to facilitate insertion and removal of the thin plug connector 100.

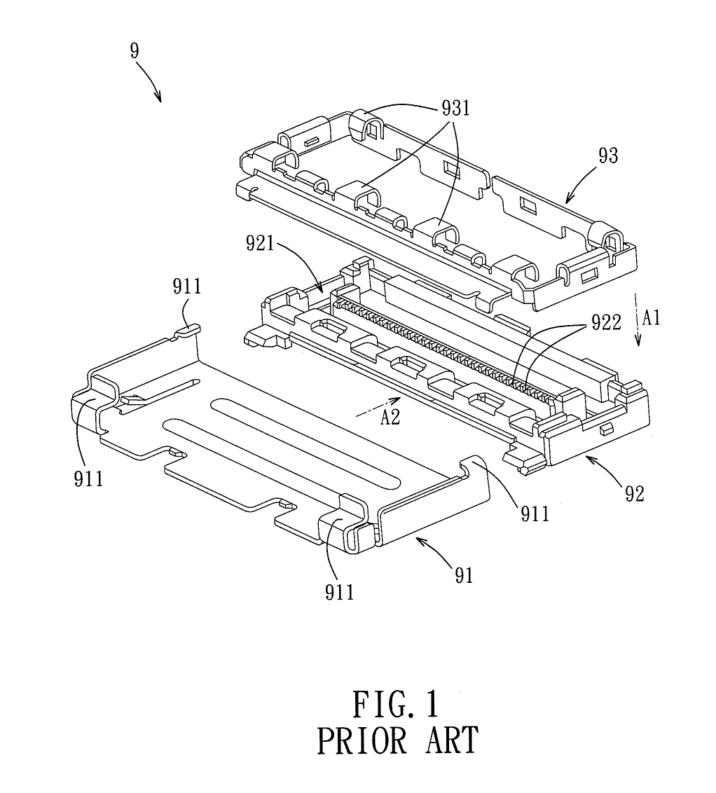

From the aforesaid description, in the first preferred embodiment, in addition to the casing 3 and the side cover 4 being attached to the insulator body 1, the insulator body 1 is also engaged to the side plate 32 and the first buckling plates 36 of the casing 3. Further, the portions of the first resilient sheets 341, 342, 343 for abutment thereagainst of the socket connector are also formed on the casing 3. Hence, comparing the side cover 4 with the conventional cover 93 (see FIG. 1), the structure of the side cover 4 of the present invention can be designed as an elongated strip so as to save material costs.

Further, the position of the engaging projections 154, 156 may be interchanged with that of the engaging holes 321, 361. That is, the side plate 32 and the first buckling plates 36 may be provided with the engaging projections, while the first and second longitudinal sidewalls 151, 152 may be provided with the engaging holes. Similarly, the position of the limiting holes 371 in the second buckling plates 37 may be interchanged with that of the limiting protrusions 441 of the third buckling plates 44.

Moreover, in this embodiment, the second buckling plates 37 are used for engaging with the respective third buckling plates 44. In an alternative embodiment, the second buckling plates 37 may be configured to be similar to the first buckling plates 36 that engage with the corresponding short sidewalls 153 of the insulator body 1.

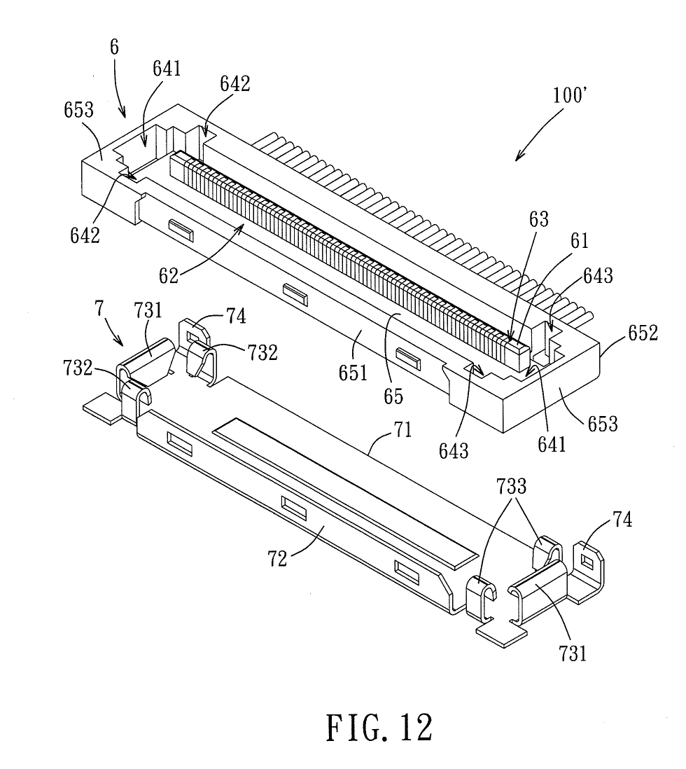

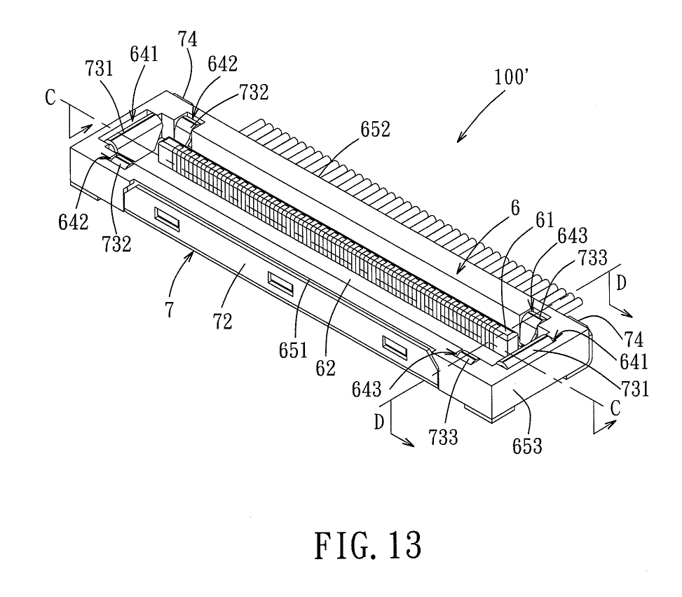

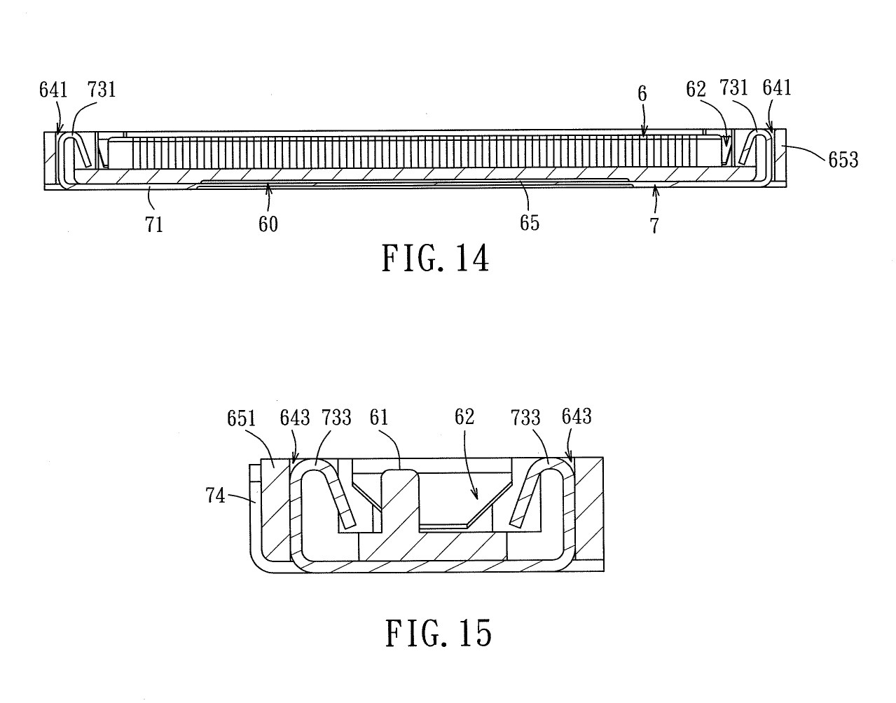

Referring to FIGS. 12 to 15, a thin plug connector 100′ according to the second preferred embodiment of the present invention is shown comprising an insulator body 6 and a casing 7. The insulator body 6 has a plate 61, a mating slot 62, a plurality of grooves 63, and a plurality of holes 64. The plate 11 protrudes from a bottom wall 65 of the insulator body 6. The insulator body 6 further has a first longitudinal sidewall 651, and a second longitudinal sidewall 652 opposite to the first longitudinal sidewall 651. The structures of the mating slot 62, the grooves 63, and the holes 64 may be similar to those described in the first preferred embodiment.

The casing 7 has a base plate 71, a side plate 72, a plurality of resilient sheets 73, and a plurality of buckling plates 74. The structures of the base plate 71, the side plate 72, and the buckling plates 74 may be similar to those described in the first preferred embodiment. In this embodiment, each resilient sheet 73 has an inverted U-shaped cross section.

When the casing 7 is attached to the insulator body 6, the side plate 72 is engaged to the first longitudinal sidewall 651, and the buckling plates 74 are engaged to the second longitudinal sidewall 652. Further, the resilient sheets 73 extend through the respective holes 64, and are closer to the mating slot 62 than the holes 64, so that when a mating socket connector (not shown) is inserted into the mating slot 62, the socket connector can contact the resilient sheets 73. Moreover, the base plate 71 abuts against a bottom side 60 (which is also a bottom face of the bottom wall 65) of the insulator body 6. That is, the entire surface of the base plate 71 is adhered to the bottom side 60 of the insulator body 6.

The difference between the first and second preferred embodiments resides in that the side cover 4 shown in FIG. 2 is omitted in the second embodiment. Since the side cover 4 is omitted, not only is the material costs reduced, but also the working hour to assemble the side cover 4 is directly eliminated.

In summary, whether it be the assembly of the casing 3 having the side cover 4 and the insulator body 1 or the assembly of the casing 7 alone and the insulator body 6, the thin plug connector 100, 100′ of the present invention, as compared to the casing 91 and the cover 93 of the conventional thin plug connector 9, has lower material costs to thereby minimize its production costs, and lesser amount of assembly time. Hence, the objects of the present invention can be realized.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. A thin plug connector comprising:
an insulator body having a plate, a mating slot, a plurality of grooves, and at least one hole, said plate protruding from said insulator body, said mating slot being formed around a periphery of said plate, said hole being adjacent to said mating slot;
a plurality of terminals inserted into said grooves, each of said terminals having a contact portion and a soldering portion, said contact portion being embedded at one side of said plate, said soldering portion being disposed at a bottom side of said insulator body; and
a casing having a first base plate, a side plate, and at least one first resilient sheet, said side plate being bent from a first longitudinal side edge of said first base plate and attached to a first longitudinal sidewall of said insulator body, wherein, said first resilient sheet extends through said hole, and is closer to said mating slot than said hole, so that said first base plate abuts against said bottom side.

2. The thin plug connector of claim 1, further including a side cover attached to a second longitudinal sidewall of said insulator body that is opposite to said first longitudinal sidewall, wherein said side cover has a second resilient sheet, an engaging hook, and a second base plate, and said second resilient sheet and said engaging hook are disposed at one side of said second base plate.

3. The thin plug connector of claim 1, wherein said casing further has a plurality of pressing plates, and said pressing plates are disposed at said side plate or a short side edge of said first base plate to be pressed against said first longitudinal sidewall of said insulator body or a short sidewall that is directly connected to said first longitudinal sidewall.

4. The thin plug connector of claim 1, wherein said casing further has a first buckling plate opposite to said side plate, and said first buckling plate is disposed on a second longitudinal side edge of said first base plate that is opposite to said first longitudinal side edge to be engaged with a second longitudinal sidewall of said insulator body that is opposite to said first longitudinal sidewall.

5. The thin plug connector of claim 1, wherein said casing further includes a plurality of buckling plates disposed on a second longitudinal side edge that is opposite to said first longitudinal side edge and two short side edges of said first base plate to be engaged with corresponding second longitudinal sidewall and two short sidewalls of said insulator body.

6. The thin plug connector of claim 1, wherein said first resilient sheet has an S- or U-shaped cross section, and said first resilient sheet has a projection protruding toward said plate.

7. The thin plug connector of claim 3, further including a side cover attached to a second longitudinal sidewall of said insulator body, and said second longitudinal sidewall is opposite to said first longitudinal sidewall, wherein, said side cover has a second resilient sheet, an engaging hook, and a second base plate, and said second resilient sheet and said engaging hook are disposed at one side of said second base plate.

8. The thin plug connector of claim 7, wherein said casing further has a second buckling plate bent from said first base plate, said side cover further has a third buckling plate bent from said second base plate, one of said second and third buckling plates has a limiting hole, and the other one of said second and third buckling plates has a limiting projection to be lodged in said limiting hole.

9. The thin plug connector of claim 1, wherein one of said side plate of said casing and said first longitudinal sidewall of said insulator body has at least one engaging hole, and the other one of said side plate of said casing and said first longitudinal sidewall of said insulator body has an engaging projection to be lodged in said engaging hole.

10. The thin plug connector of claim 1, wherein said casing body has a plurality of first resilient sheets, and said first resilient sheets are bent from said first longitudinal side edge of said first base plate, a second longitudinal side edge that is opposite to said first longitudinal side edge, and a short side edge that is connected to said first longitudinal side edge and said second longitudinal side edge.

11. An assembling method of the thin plug connector which is claimed in claim 1, comprising:
providing said insulator body that has said terminals such that said contact portions of said terminals are embedded at one side of said plate, and said soldering portions of said terminals are disposed at a bottom side of said insulator body, wherein said insulator body further has a mating slot and a hole, said mating slot is formed around a periphery of said plate, and said hole is adjacent to said mating slot; and
attaching a casing on said bottom side of said insulator body, wherein said casing includes a first base plate, a side plate, and a first resilient sheet, said side plate is bent from a longitudinal side edge of said first base plate, and said first resilient sheet extends through said hole and is closer to said mating slot than said hole, so that said first base plate abuts against said bottom side.

12. The assembling method of claim 11, wherein a forming method of said insulator body includes insert molding or conventional mechanical assembling method.

13. The assembling method of claim 11, wherein, the method for attaching said casing on said insulator body further includes connecting electrically a plurality of cables with said soldering portions, so that said cables are covered within said casing.

14. The assembling method of claim 11, further including attaching a side cover to the other side of said casing, so that said casing and said side cover are engaged to each other.

15. The assembling method of claim 11, wherein, when said casing is attached to said insulator body, a plurality of pressing plates attached to said side plate and a periphery of said first base plate are bent to be pressed against said insulator body.

16. The assembling method of claim 11, wherein, when a longitudinal sidewall of said insulator body is attached to said side plate, a plurality of buckling plates of said casing are attached to the other longitudinal sidewall of said insulator body that is opposite to said longitudinal sidewall.
